(19) United States
(12) Patent Application Publication
(10) Pub. No.: US 2008/0108403 A1
(43) Pub. Date: May 8, 2008

(54) Liar's Poker online

(76) Inventor: Jeff Lewis, New York, NY (US)

Correspondence Address: SCHULTE ROTH & ZABEL LLP;ATTN: JOEL E. LUTZKER, 919 THIRD AVENUE, NEW YORK, NY, 10022, US

(21) Appl. No.: 11/594,413

(22) Filed: Nov. 8, 2006

(51) Int. Cl. A63F 13/00

(52) U.S. Cl. 463/13

(57) ABSTRACT

A method for providing and playing a “liar's poker” game online or on a portable game system is provided. The game provides a virtual table for players to “sit”, generates a random serial number for each player, receives bid or challenges from the players until all players have challenged the last made bid, determines and displays the best hand available, and displays the winning and losing hands.

### BACKGROUND OF THE INVENTION

The Invention herein relates to a method for of playing and running a game of Liar's Poker online. More specifically the invention involves a method of simulating the U.S. currency bills normally used in the Liars Poker game and providing a method for betting on same. The game can be played for real money or for credits or in game money in a gaming community. The invention also relates to a method of charging for the service of providing the online Liars Poker game to the players.

1. Field of the Invention

Liars Poker is a popular game that can be played with a large number of players and no supplies. While there are a number of versions of Liars Poker, this invention most particularly deals with the version wherein each players hand consists of an issued U.S. Currency bill, which has a serial number consisting of 8 numbers and several letters. Each player can see his own bill's serial number, but not the serial number on the bills of the other players. Each player looks at his own bill's serial number and attempts to determine the best possible “poker hand” that can be made with the numbers from all the bills in play in the game

Poker in all its forms, has long been a popular form of entertainment. Recently, online games, and particular online poker games of every sort have also become a popular form of entertainment. Normally, the games are independent of the users platform and only require the user to utilize a web browser (for accessing the Internet) and the software plug-in associated with the game. The present invention may be used in conjunction with such a system. For example, the software for supporting the present invention may reside on the server and platform associated with one of the many existing gaming web sites, or on a web site specifically built and designed to support the software for implementing the present invention. The mechanism for writing the software and implementing the hardware for supporting the present invention are well known in the gaming field.

At online poker websites, players may gather from all over the world to participate. Online sites provide simulated tables for poker games, and the games can be played for real money or play/game money, such as online game community credits. Online poker tables typically seat up to 10 players per table, online poker also allows players to play more than one hand at a time by having separate windows for each table the player is playing a hand at.

Online poker typically has the disadvantage that a player cannot observe the opponents, but it allows players who would other wise not have the opportunity to travel to a casino or poker game to have access to a game. Further, online play allows players to anonymously play from the comfort of their own home 24 hours a day, 7 days a week.

Poker, in any form has always been considered a game which requires high levels of skill, despite the inherent luck involved. This is often seen in players who would otherwise play choosing not to play at a particular table or with particular opponents because they lack the requisite skill. Liar's Poker in particular is a game of skill. While the numbers on each player's bill are random, either through random generation (such as in the present invention) or through random bill selection, the makeup of that bill has a minor effect on the outcome of the game. Playing with two players, a single player's bill makes up only half of the available data. Playing with three, only one third, and so on. In the standard six-person game, most of the data that will determine the best possible hand is unknown by each player. The game is one of imperfect information and the search for information that is provided by communicating via the bidding process with the other players. Winners do the best job of interpreting the information provided to them by the other players and the best job of providing as little valid information as possible in return. The crux of the game is communication and interpretation, not the random numbers.

Due to the fact that Liar's Poker is played with issued U.S. currency bills, it is difficult to play the game online where the bills of the opponents cannot be checked. The present invention provides a means of running a game of Liar's Poker online that simulates the U.S. currency bills and therefore allows authentic Liar's Poker play in an online situation.

2. Description of the Prior Art

Computerized versions of Liar's poker have been provided which provide a version of the game which uses the amount bet to set the required winning bid and which allow for play against the computer. However these games do not simulate the skill aspects of Liar's Poker or the interaction between players in the bidding/raising rounds.

Online versions of poker have been described in the prior art. However, these versions do not simulate the game of Liar's Poker as played herein.

### SUMMARY OF THE INVENTION

The primary object of the invention is to provide an easy to play online version of Liar's Poker.

Another object of the invention is to simulate the nature of play of a game of Liars Poker when using U.S. currency bills provided by each of the players.

Yet another object of the invention is to provide an easy means to track the bidding and challenging in an online game without hindering the game play.

Yet another object of the invention is to provide an easy means to determine the winning hand and determine the winning player.

Yet another object of the invention is to provide a means for the host of the online game to extract a fee directly from the players for each hand.

Yet another object of the invention is to provide an easy to play version of Liar's Poker for hand held and/or portable game systems which communicate with each other without use of the internet.

In an aspect of this invention a method is provided for providing a game that is played online such as via the Internet so that a user may play against other remote players. This method includes utilizing a computer to generate for each player a random serial number which is displayed via the Internet to that individual player in the form of a mock up bill. During play, each player looks at his own bill's serial number and attempts to determine the best possible “poker hand” that can be made with the numbers from all the bills in play in the game. The random generated serial number may have 8 digits as in United States currency or some other number of digits.

The only possible “poker hand” is a grouping of the same card (“a pair, three of a kind, four of a kind, etc.”). The numbers represent a card of the same number, with a “0” on the bill representing a “10”, and the best “card” being a 1 representing an “Ace.” For example if Player A has 12345678 and Player B has 34567890, then the best possible hand that could be called from the two bills would be a pair of 8s. As with standard forms of poker, more of the same card, or the same number of a higher card would represent a better hand. For example, three 8s beat two 8s, and three 1s beat three 8s. The players bid hands by making a statement of what they believe to be the best hand that could be made from the serial numbers of all the bills in play. For example, in the same two hand game between Player A and Player B, player A might start by bidding two threes. The next player must do one of two things: challenge or raise.

After the initial player has bid, the other players (and eventually the first player when it is his turn again), may in turn raise or challenge. A “raise” is a bid (or statement) of a hand that would defeat the previous bid as explained above. In the example, Player B would have to bid at least two 4s or challenge. In the present invention, a player raises by filling in the quantity and value of his bid in provided cells via a computer interface and then selecting a Bid/Raise button through the computer interface. A “challenge” is a statement that the player believes that the best possible hand is weaker than the previous bid. The players will continue taking turns raising or challenging until all the players except one have challenged the bid of the remaining player.

When a bet is challenged every player who challenged the bid has locked in a bet against the bidder for the unit of the table. In the invention a player challenges by hitting a provided challenge button through the computer interface. A player challenged by all other players, has one opportunity to raise his own bid. Then the other players must once again decide to bid or raise once a player is challenged by all other players twice, the hand ends and the computer shows all the mock bills and determines the best hand available. Based on this determination a winner is decided upon, and the funds credited and debited automatically. For example, in the two hand example, if Player A bids two 8s, and Player B challenges, A will win as each bill has an 8. If B raises, and A calls, B will lose because two 8s is the best possible hand.

The game can be played in a variety of virtual environments. In one preferred embodiment of the invention, the environment would be a representation of a wall street trading desk. In such an environment, the bids and raises would be displayed on virtual computer monitors which represent each player. These virtual computer monitors are displayed via the Internet on each players' own computer or other internet platform. Additionally, in this preferred embodiment, advertisements could be placed on the virtual desk on virtual items such as a soda can, blackberry, deck of cards, cell phone or other common item.

### BRIEF DESCRIPTION OF THE DRAWING

The invention is illustrated by way of example and not limitation and the figures of the accompanying drawings in which like reference s denote like or corresponding parts:

FIG. 1 is a view of the display that a player of the game would see on his computer, portable game device or other online platform when playing Liar's Poker using one embodiment of the invention.

FIG. 2 is a flow diagram illustrating the flow of play of a game of Liar's Poker provided online or on a portable game device using one embodiment of the invention.

### DETAILED DESCRIPTION OF INVENTION

In the following description of exemplary embodiments, reference is made to the accompanying drawings which form a part hereof, and in which is shown by way of illustration a display which may be used when the invention is practiced. It is understood that other displays may be utilized, as display, operational and structural changes may be made without departing from the scope of the present invention.

Generally, the present invention provides an online game and a manner of providing such online game. The invention provides a manner for allowing the play of Liars Poker through the use of mock currency and a easy to use bidding system. More particularly, the invention is implemented through the use of randomly generated serial numbers which mimic the serial numbers found on U.S. issued currency. Thus the players are able to play as if they were using currency from their wallet, despite playing online.

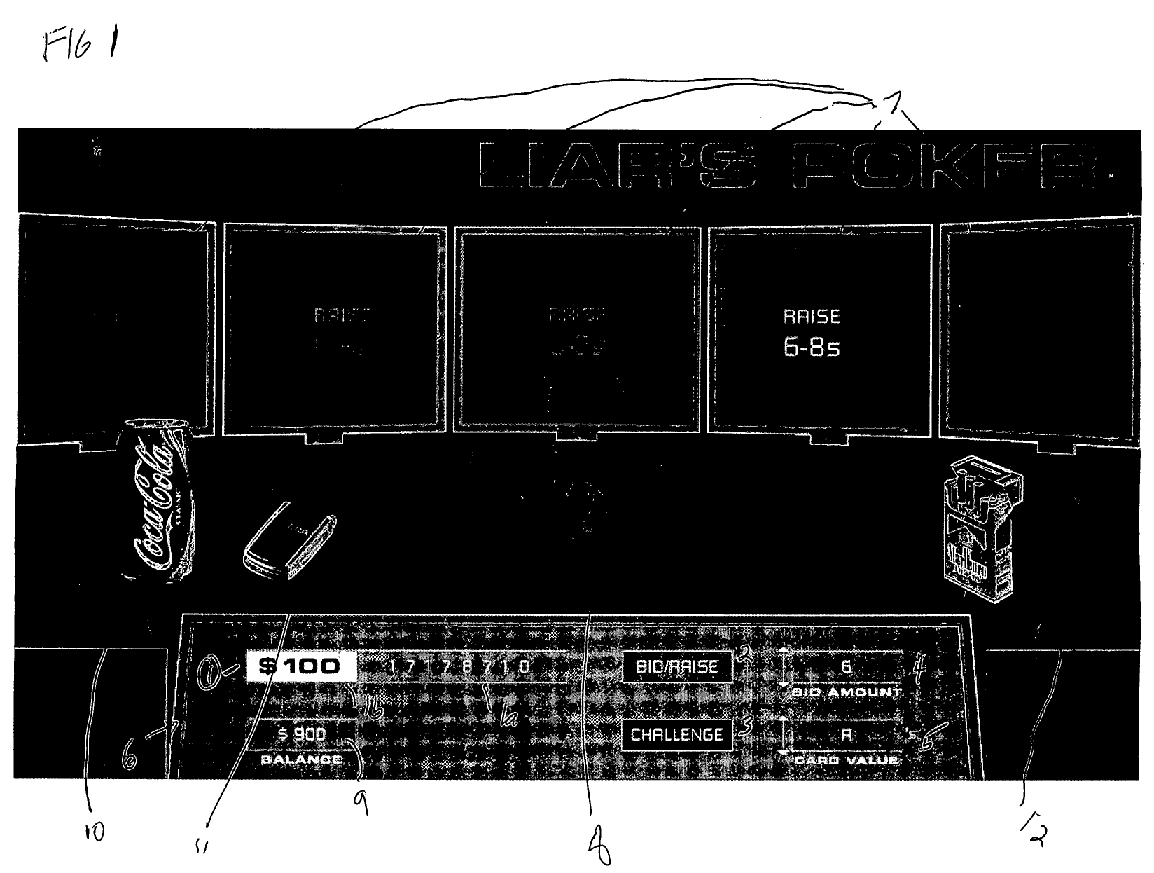

In accordance with the invention and as shown in FIG. 1, in the online version a mockup of currency 1 is displayed on the screen next to seats at a virtual table. A randomly generated sequence of numbers (1a) together with the currency unit bid (1b) appears in each players mock currency 1. A player's sequence is viewable only by the individual player until the end of the hand when the winning hand is displayed. The periphery 6 of the players mockup currency 1 will flash when the player's turn to play comes up.

Near each mockup currency 1 are displayed two buttons 2 and 3: These are the BID/RAISE (B/R) button 2 and a CHALLENGE button 3. Also displayed will be two cells, Quantity or Bid Amount 4 and Card Value 5, which can be filled in by the player. The B/R button 2 will only activate if the player has filled in both the Quantity cell 4 and Card Value cell 5. A placed bid will be displayed to all players in a display area 7, and the bid will remain visible for the duration of the hand or until it is replaced when the player raises his own bid. A bid which has been raised will be denoted with an R next to it.

Finally, next to the each players mockup currency may also be displayed the player's account 9, which displays the amount of funds available to be bet on hands.

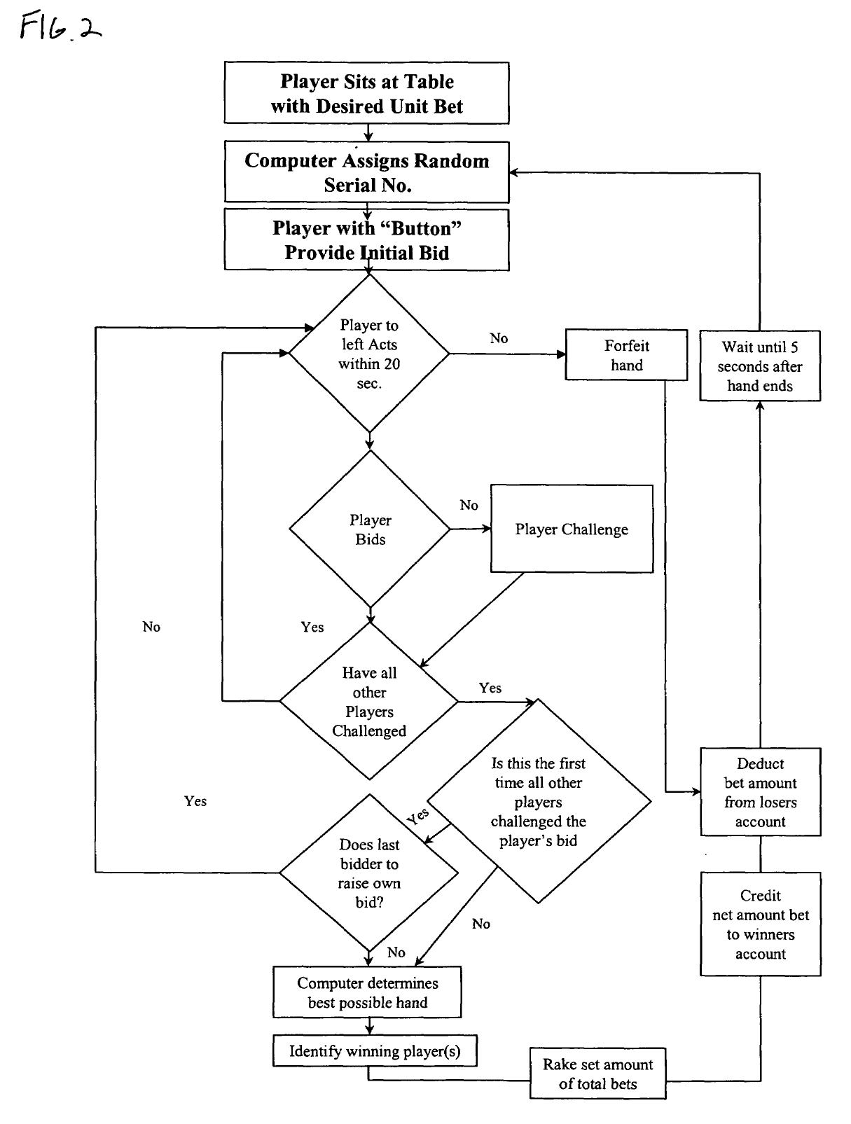

FIG. 2 is a flow diagram illustrating one embodiment of the play of the present invention. In the illustrated embodiment, the game can begin when more than one player has been “seated” at the virtual table. Every five seconds after a game ends, a new game starts with a number of players equal to the number of players seated. A player sits at a table which determines the unit ($1, $5, $10, $20, etc.) being bet on each hand at that table. All players therefore, will bet the same unit of currency. The units can be in real currency or in credits or other online community based units.

At the beginning of the game an indicator, similar to the “button” in physical poker will rotate around the table to determine who bids first. When the game starts, a randomly generated sequence of numbers 1a together with the currency unit bid 1b will appear in each player's mock currency 1. A player's sequence is viewable only by the individual player until the end of the hand when the winning hand is displayed.

The periphery 6 of the players mockup currency 1 will flash when their turn to play comes up. A Player will have 20 seconds to either bid/raise or challenge an existing bid. If the player does not act within the 20 seconds, the amount of the bet will be forfeited. A bid is placed by filling in the number of the “cards” of the bid in the Card Value Cell 5 and the number of those cards in the Quantity cell 4. For example bidding three 8's would require putting “3” in Quantity cell 4 and “8” in Card Value cell 5.

A placed bid will be displayed to all players in a display area 7, the bid will remain visible for the duration of the hand or until it is replaced when the player raises his own bid. A bid which has been raised will be denoted with an R next to it. After a bid is placed, the periphery of the mock currency of the next player in turn'(1) will flash, indicating that it is their turn, the turn sequence will repeat for each player until all players except the last bidder have challenged a single bid. At this time the last bidding player will have one opportunity to raise his own bidIf the last player raises his bid, then the turn repeats for all players until all the players challenge the last bidder a second time. After each player has had the opportunity to challenge a second time, the hand is over. When the hand is over, the best hand is indicated in the center of the screen 8, all of the player's mock bills will be revealed, the winner's mock bill will turn green and the losers mock bills will turn red.

The hosting website will automatically deduct the unit in play from each loser's account and will credit each winner's account 9 an amount equal to the total of losing player's bids.

In one embodiment of the invention, the operator of the hosting website will take an automatic “rake,” or percentage of the total units in play on each hand in order to profit on the games. For example, a host could set the rake to deduct 5% of each hand to a maximum of $1 per player.

In another embodiment of the invention, the game is provided on software used in portable hand held game systems which can communicate directly with each without accessing the internet. The game play and visual embodiments for such version are the same as if it were online, but without the need for a hosting website. Instead, the portable system's software will provide the game, and the systems will communicate between the players for purposes of providing the tables.

In this embodiment, an additional first step is added, wherein the player is given a choice of either searching for an existing table within range or creating a table. If the player searches for a table, the system will detect if any portable system within range is hosting a table, and the player will have a choice to sit at any tables that are located. If the player elects to create a table, the player's portable system will provide a signal to other portable systems that it has a table available for other players to sit at. Once the players have seated themselves at the table, the game proceeds as described above.

For the convenience of the reader, the above description focused on representative samples of all possible embodiments that teaches the principles of the invention and conveys the best mode contemplated for carrying it out. The description has not attempted to exhaustively enumerate all possible variations. Other undescribed variations or modifications may be possible. For example, where multiple alternative embodiments are described, in man cases it will be possible to combine elements of different embodiments, or to combine elements of the embodiments described here with other modifications or variations that are not expressly described. Many of those undescribed variations, modifications and alterations are within the literal scope of the following claims and others are equivalent.

FIG. 1 also shows one preferred embodiment of the invention, in which the environment would be a representation of a wall street trading desk. In such an environment, the bids and raises would be displayed on virtual computer monitors 7 which represent each player. This preferred embodiment shows advertisements placed on the desk on virtual items such as a soda can 10, cell phone 11, cigarettes 12, as examples. Other virtual representations of common items could be used for such advertising space.

I claim:

1) A method for providing a game online, comprising providing a virtual table for players to “sit”; generating a random serial number for each player; randomly selecting a first player from among the seated players; receiving a bid placed by the first player; receiving a bid or challenge by each successive player; repeating the bidding or challenge step until all players have challenged the last made bid; determining and displaying the best hand available; displaying the winning and losing hands.

2) The method of claim 1, wherein the serial number is displayed on a mock currency unit.

3) The method of claim 1, wherein the amount of the bet is determined by the table.

4) The method of claim 1 wherein a player places a bid using card value and quantity cells which can be filled in over the internet.

5) The method of claim 4, wherein the player enters the number of “cards” or numbers from the serial number included in the bid in the Quantity cell, and the number from the serial number in the Card Value cell.

6) The method of claim 1, wherein the player who placed the last bid may raise his own bit once after all other players have challenged his bid.

7) The method of claim 1, wherein the best hand is determined by taking all of the numbers from the player's serial numbers and determining the largest combination of the same number that can be made, and if two or more numbers have the same largest combination, the higher of the numbers.

8) The method of claim 7, wherein a 0 in the serial number represents a 10.

9) The method of claim 7, wherein a 1 in the serial number represents an Ace, which is higher than a 10.

10) The method of claim 1, wherein the best hand is displayed in the center of the screen

11) The method of claim 1, wherein the winner is determined by comparing the bidding player's bid against the best hand.

12) The method of claim 1, wherein the winning player's bill is turned green and the loosing players hand is turned red.

13) The method of claim 1, wherein the bids are displayed in a display area of the screen;

14) The method of claim 13, wherein a raised bid is denoted with an R.

15) The method of claim 1, wherein the amount of the bid is automatically deducted from the loosing player's account.

16) The method of claim 1, wherein the amount of the bit times the number of players is automatically credited to the winning player's account.

17) The method of claim 1, wherein the virtual table can seat up to 6 players.

18) The method of claim 1, wherein the virtual table is displayed as a wall street table.

19) The method of claim 18, wherein the virtual table contains advertisements in the form of virtual representations of items.

20) The method of claim 19, wherein an advertisement is on a virtual representation of a soda can.

21) The method of claim 19, wherein an advertisement is on a virtual representation of a carton of cigarettes

22) The method of claim 19, wherein an advertisement is on a virtual representation of a cell phone.

23) A method for providing a game playable on portable game systems with the ability to communicate with other portable game systems, comprising providing the virtual table for players to “sit”; generating a random serial number for each player; randomly selecting a first player from among the seated players; receiving a bid placed by the first player; receiving a bid or challenge by each successive player; repeating the bidding or challenge step until all players have challenged the last made bid; determining and displaying the best hand available; displaying the winning and losing hands.

24) The method of claim 23, wherein the player can select to create a table of search for existing tables.

25) The method of claim 24, wherein the player selecting to create a table sets the amount of the bet.

26) The method of claim 24, wherein the portable game device transits a signal to notify other portable systems of the existence of the newly created table and the amount of the bet.

27) A method for playing a game online, comprising “sitting” at a virtual table; generating a random serial number for each player; randomly selecting a first player from among the seated players; making a bid by the first player; raising or challenging the bid by each successive player, repeating the bidding or challenge step until all players have challenged the last made bid; determining and displaying the best hand available; displaying the winning and losing hands.

28) The method of claim 27, wherein the amount of the bet is determined by the table.

29) The method of claim 27 wherein a player places a bid using card value and quantity cells which can be filled by the player.

30) The method of claim 29, wherein the player enters the number of “cards” or numbers from the serial number included in the bid in the Quantity cell, and the number from the serial number in the Card Value cell.

31) The method of claim 27, wherein the player who placed the last bid may raise his own bit once after all other players have challenged his bid.

32) The method of claim 27, wherein the best hand is determined by taking all of the numbers from the players serial numbers and determining the largest combination of the same number that can be made, and if two or more numbers have the same largest combination, the higher of the numbers.

33) The method of claim 32, wherein a 0 in the serial number represents a 10 and a 1 in the serial number represents an Ace, which is higher than a 10.

34) The method of claim 27, wherein the best hand is displayed in the center of the screen

35) The method of claim 27, wherein the winner is determined by comparing the bidding player's bid against the best hand.

36) The method of claim 27, wherein the winning player's bill is turned green and the loosing players hand is turned red.

37) The method of claim 27, wherein the amount of the bid is automatically deducted from the loosing player's account.

38) The method of claim 27, wherein the amount of the bit times the number of players is automatically credited to the winning player's account.
